(19) United States
(12) Patent Application Publication
(10) Pub. No.: US 2007/0246361 A1
(43) Pub. Date: Oct. 25, 2007

(54) Gas sensor with increased sealing performance

(75) Inventors: Toshikazu Hirose, Anjo-shi (JP); Kiyomi Kobayashi, Kuwana-shi (JP); Makoto Nakae, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/783,332

(22) Filed: Apr. 9, 2007

(30) Foreign Application Priority Data
Apr. 20, 2006 (JP) 2006-116995

(51) Int. Cl. G01N 27/26

(52) U.S. Cl. 204/431

(57) ABSTRACT

A gas sensor and method of manufacturing the gas sensor are disclosed. The gas sensor comprises a gas sensing element, an insulating element holder having an element inserting bore through which the gas sensing element axially extends, a housing fixedly supporting the insulating element holder, an airtight sealant and a cushioning filler. Ceramic slurry, composed of at least ceramic powder and binder, is filled in an area between the gas sensing element and the insulating element holder on a leading end portion of the element inserting bore and fired to form a cushioning filler. The ceramic slurry contains 47 to 53 wt % of ceramic solids for a gross weight of ceramic slurry and a binder laying in a value ranging from 5 to 10 wt % for a weight of the ceramic solids.

### CROSS REFERENCE TO RELATED APPLICATIONS

This application is related to Japanese Patent Application No. No. 2006-116995, filed on Apr. 20, 2006, the content of which is hereby incorporated by reference.

### BACKGROUND OF THE INVENTION

1. Technical Field of the Invention

The present invention relates to methods of manufacturing gas sensors for use in controlling combustion states of internal combustion engines such as automotive engines and, more particularly, to a method of manufacturing a sensor for detecting a concentration of specified gas in measuring gases for use in controlling a combustion state of an internal combustion engine such as an automotive engine.

2. Description of the Related Art

With the development of automotive engines, attempts have heretofore been made to install gas sensors on exhaust pipes of internal combustion engines such as automotive engines each for detecting a concentration of specified gas such as oxygen in measuring gases.

Each of the gas sensors comprises a gas sensing element for detecting a concentration of specified gas in measuring gases and an insulating element holder (porcelain insulator) formed with an element inserting bore through which the gas sensing element axially extends and retained in fixed place.

With such a structure, an airtight sealant is located between the gas sensing element and the insulating element holder on a base end portion thereof to firmly seal and retain the gas sensing element. That is, an interspace between the gas sensing element and the insulating element holder serves as a boundary between an atmospheric ambience and a measuring gas ambience. Thus, the interspace between these two components needs to take a hermetically sealed structure so as to void the mixing of gases in both ambiences.

Further, the element inserting bore formed in the insulating element holder has a size slightly greater than an outer contour of the gas sensing element to providing a clearance for the gas sensing element to be easily inserted through the insulating element holder. With the gas sensing element fixed retained in the insulating element holder, the gas sensing element is liable to suffer large impacts vibrations applied to the gas sensor from the outside during operation on the automotive engine. When this takes place, a leading end portion of the gas sensing element vibrates in a pendulating mode (referred to as “element pendulation”) and troubles arise with the occurrence of the gas sensing element colliding with an inner wall of the element inserting bore of the insulating element holder. To prevent such a collision between the gas sensing element and the insulating element holder, an attempt has heretofore been made to provide a cushioning filler between a gas sensing element and an insulating element holder on a leading end portion thereof as disclosed in U.S. Pat. No. 6,813,930.

With such a structure of the gas sensor of the related art, the gas sensing element can be supported with the insulating element holder on two points thereof at the base end portion and the leading end portion thereof. This enables a reduction in impact forces (hereinafter referred to as momentum) acting on the gas sensing element in a direction perpendicular to an axis of the gas sensing element due to the gas sensing element suffering element pendulation encountered at a leading end portion thereof. Accordingly, such a supporting structure of the gas sensing element can prevent the gas sensing element from being damaged due to stress concentration occurring on a fulcrum of vibration resulting from element pendulation or impact encountered in collision with the internal sidewall of the element inserting bore.

However, such cushioning filler of the related art has an issue with the occurrence of inadequate strength and a probability exists with a difficulty of effectively suppressing the occurrence of element pendulation. That is, there is a fear of the cushioning filler being damaged when impairs occur on the gas sensor. Thus, an issue arises with a fear that the gas sensing element can be damaged due to external shocks.

### SUMMARY OF THE INVENTION

The present invention has been completed with a view to addressing the above issues and has an object to provide a method of manufacturing a gas sensor that is effective in preventing a gas sensing element from being damaged even if the gas sensor encounters impact shocks applied from the outside.

To achieve the above object, a first aspect of the present invention provides a method of manufacturing a gas sensor having a gas sensing element for detecting a concentration of specified gas in measuring gases, an insulating element holder having an element inserting bore for supporting the gas sensing element and a housing internally holding the insulating element holder in a fixed place. The method comprises the steps of applying an airtight sealant to the insulating element holder on a base end portion thereof for fixedly retaining the gas sensing element, and locating a cushioning filler between the gas sensing element and the insulating element holder on a leading end portion thereof. The cushioning filler locating step comprises filling a leading end portion of the element inserting bore in an area between the gas sensing element and the insulating element holder with a ceramic slurry containing at least a ceramic powder and a binder, and firing the ceramic slurry to form the cushioning filler. The ceramic slurry contains 47 to 53 wt % of ceramic solids for a gross weight of the ceramic slurry and a binder laying in a value ranging from 5 to 10 wt % for a weight of the ceramic solids.

With such a manufacturing method, the ceramic slurry contains 47 to 53 wt % of ceramic solids for a gross weight of the ceramic slurry and contains 5 to 10 wt % of binder for a weight of the ceramic solids. This gives the cushioning filler increased strength whereby the gas sensing element can be firmly supported with the insulating element holder, enabling the gas sensor to have increased shock-proof capability.

Upon the execution of filling step and firing step, the ceramic slurry with increased strength can be formed into the cushioning filler between the gas sensing element and the insulating element holder at the leading end portion thereof. This results in capability of the gas sensing element being firmly supported with the cushioning filler having increased strength, thereby preventing the gas sensing element from being damaged due to element pendulation.

That is, the manufacturing method of the present invention makes it possible to easily manufacture a gas sensor that can effectively prevent a gas sensing element from being damaged.

As set forth above, the present invention provides a method of manufacturing a gas sensor that can prevent the occurrence of damage on a gas sensing element.

With the method of manufacturing the gas sensor, if the content of the ceramic solids is out of the range from 47 to 53 wt % or if the content of binder is out of the range from 5 to 10 wt %, there is a fear of the gas sensor encountering a difficulty of obtaining the increased strength cushioning filler.

With the method of manufacturing the gas sensor, the ceramic powder may have an average particle diameter ranging from 10 to 30 μm in the filling step.

With the ceramic powder selected to have such an average particle diameter, the ceramic slurry can be filled into a targeted area between the gas sensing element and the insulating element holder in a reliable manner. This enables the cushioning filler to be formed with increased strength in a reliable fashion.

On the contrary, if the average particle diameter of the ceramic powder is less than 10 μm, the ceramic powder is filled into the targeted area in high density. This results in a reduction in voids among particles with the resultant decrease in impact absorbing ability. Thus, the cushioning filler becomes hard to have adequate strength.

Further, if the average particle diameter of the ceramic powder is greater than 30 μm, the ceramic powder is composed of large ceramic particles in major proportion. This results in a reduction in contact points among the particles during firing step. Thus, a drop takes place in a binding force between adjacent particles, causing a deterioration to occur in strength of the cushioning filler.

With the method of manufacturing the gas sensor, the filling step may be conducted so as to fill the leading end portion of the element inserting bore with the ceramic slurry such that upon completion of the firing step, the cushioning filler seals and fixes the gas sensing element on at least four corners thereof on a plane substantially perpendicular to an axis of the gas sensing element.

In such a case, the gas sensing element can be firmly supported with the cushioning filler at the four corners of the gas sensing element. This enables a reduction in momentum acting on the gas sensing element due to element pendulation, while making it possible to allow the cushioning filler to effectively absorb impacts or vibrations applied to the gas sensing element from the outside.

With the method of manufacturing the gas sensor, the ceramic powder may include ceramic materials selected from the group consisting of alumina powder and zirconium powder.

With the method of manufacturing the gas sensor, the binder may include materials selected from the group consisting of alumina sol and aluminum nitrate.

A second aspect of the present invention provides a method of manufacturing a gas sensor, comprising the steps of preparing a gas sensing element for detecting a concentration of specified gas in measuring gases, preparing an insulating element holder having an element inserting bore through which the gas sensing element extends and is fixedly retained, forming an airtight sealant between the gas sensing element and the insulating element holder on a base end portion thereto, and locating a cushioning filler between the gas sensing element and the insulating element holder on a leading end portion thereof. The cushioning filler locating step comprises filling a leading end portion of the element inserting bore in an area between the gas sensing element and the insulating element holder with a ceramic slurry containing at least a ceramic powder and a binder, and firing the ceramic slurry to form the cushioning filler. The ceramic slurry contains 47 to 53 wt % of ceramic solids for a gross weight of the ceramic slurry and a binder laying in a value ranging from 5 to 10 wt % for a weight of the ceramic solids.

With such a manufacturing method, the ceramic slurry contains 47 to 53 wt % of ceramic solids for a gross weight of ceramic slurry and a binder laying in a value ranging from 5 to 10 wt % for a weight of the ceramic solids. Such ceramic slurry enables the cushioning filler with increased strength to be formed between the gas sensing element and the insulating element holder on the leading end portion thereof. Thus, the gas sensing element can have increased shock-proof capability.

Upon the completions of filling step and firing step, the cushioning filler can be formed of the ceramic slurry between the gas sensing element and the insulating element holder thereby rigidly supporting the gas sensing element with increased strength. This enables the cushioning filler to effectively absorb impacts or vibrations acting on the gas sensing element, thereby preventing the occurrence of element pendulation.

That is, the manufacturing method of the present invention makes it possible to easily manufacture a gas sensor that can effectively prevent a gas sensing element from being damaged.

With the method of manufacturing the gas sensor, if the content of the ceramic solids is out of the range from 47 to 53 wt % or if the content of binder is out of the range from 5 to 10 wt %, there is a fear of the gas sensor having a difficulty of obtaining the cushioning filler with increased strength.

With the method of manufacturing the gas sensor, the ceramic powder has an average particle diameter ranging from 10 to 30 μm in the filling step.

With the ceramic powder having such an average particle diameter, the filling step being reliably carried out to fill ceramic slurry into a targeted area between the gas sensing element and the insulating element holder. This enables the cushioning filler to be formed with increased strength in a reliable fashion.

In contrast, if the average particle diameter of the ceramic powder is less than 10 μm, the ceramic powder is filled into the targeted area in high density. This results in a reduction in voids among particles with the resultant decrease in impact absorbing ability. Thus, the cushioning filler becomes hard to have adequate strength.

Further, if the average particle diameter of the ceramic powder is greater than 30 μm, the ceramic powder is composed of large ceramic particles in major proportion. This results in a reduction in contact points among the particles during firing step. Thus, a drop takes place in a binding force between adjacent particles, causing a deterioration to occur in strength of the cushioning filler.

With the method of manufacturing the gas sensor, the filling step may be conducted so as to fill the leading end portion of the element inserting bore with the ceramic slurry such that upon completion of the firing step, the cushioning filler seals and fixes the gas sensing element on at least four corners thereof on a plane substantially perpendicular to an axis of the gas sensing element.

In such a case, the gas sensing element can be firmly supported with the cushioning filler at the four corners of the gas sensing element. This enables a reduction in momentum acting on the gas sensing element due to element pendulation, while making it possible to allow the cushioning filler to effectively absorb impacts or vibrations applied to the gas sensing element from the outside.

With the method of manufacturing the gas sensor, the ceramic powder may include ceramic materials selected from the group consisting of alumina powder and zirconium powder.

With the ceramic powder composed of such ceramic materials, the cushioning filler can have increased high-temperature-tolerant property. Thus, even under situations where the gas sensor is exposed to high temperatures in repeated cycles, the gas sensor can have increased operating life.

With the method of manufacturing the gas sensor, the binder may include materials selected from the group consisting of alumina sol and aluminum nitrate.

With the binder composed of such compounds, the cushioning filler can be formed with increased high-temperature-tolerant property. This allows the gas sensor to have increased operating life even if the gas sensor is exposed to high temperatures in repeated cycles.

A third aspect of the present invention provides a gas sensor comprising a cylindrical insulating element holder having an element inserting bore extending from a base end to a distal end thereof, a gas sensing element extending through the element inserting bore of the insulating element holder, a cylindrical housing internally supporting the insulating element holder in fixed place, an airtight sealant provided between the gas sensing element and the insulating element holder on a base end portion thereof, and a cushioning filler provided between the gas sensing element and the insulating element holder on a leading end portion thereof for sealing a clearance between an inner wall of the element inserting bore and an outer surface of the gas sensing element. The cushioning filler is formed of a ceramic slurry, including a ceramic powder containing 47 to 53 wt % of ceramic solids for a gross weight of the ceramic slurry and a binder laying in a value ranging from 5 to 10 wt % for a weight of the ceramic solids, which is filled between the gas sensing element and the insulating element holder on the leading end portion thereof upon which the ceramic slurry is fired to form the cushioning filler.

With the gas sensor of the present embodiment set forth above, the ceramic powder may have an average particle diameter ranging from 10 to 30 μm.

With the ceramic powder having such an average particle diameter, ceramic slurry can be filled into a targeted area between the gas sensing element and the insulating element holder in a reliable manner. This enables the cushioning filler to be formed with increased strength in a reliable fashion.

In a case where the average particle diameter of the ceramic powder is less than 10 μm, the ceramic powder is filled into the targeted area in high density. This results in a reduction in voids among particles with the resultant decrease in impact absorbing ability. Thus, the cushioning filler becomes hard to have adequate strength.

Further, in another case where the average particle diameter of the ceramic powder is greater than 30 μm, the ceramic powder is composed of large ceramic particles in major proportion. This causes a reduction to occur in contact points among the particles during firing step. This results in a drop in a binding force between adjacent particles, causing a deterioration to occur in strength of the cushioning filler.

With the gas sensor of the present embodiment set forth above, the element inserting bore of the cylindrical insulating element holder may have a rectangular shape in cross section and the gas sensing element may have a rectangular shape in cross section smaller than that of the element inserting bore of the cylindrical insulating element holder to provide a ring-like space in which the cushioning filler is formed.

With such a structure of the gas sensor, the gas sensing element can be firmly supported with the cushioning filler filled in the ring-like space at four corners of the gas sensing element. Thus, the gas sensing element can have increased shock-proof withstanding impacts of vibrations acting on the gas sensing element during operation of the gas sensor. This addresses the issue of element pendulation during operation of the gas sensor. Thus, the gas sensor can have increased operating life.

With the gas sensor of the present embodiment set forth above, the ceramic powder may include ceramic materials selected from the group consisting of alumina powder and zirconium powder.

With the ceramic powder composed of such ceramic materials, the cushioning filler can have increased high-temperature-tolerant property. Thus, even under situations where the gas sensor is exposed to high temperatures in repeated cycles, the gas sensor can have increased operating life.

With the gas sensor of the present embodiment set forth above, the binder may include materials selected from the group consisting of alumina sol and aluminum nitrate.

With the binder composed of such compounds, the cushioning filler can be formed with increased high-temperature-tolerant property. This allows the gas sensor to have increased operating life even if the gas sensor is exposed to high temperatures in repeated cycles.

### BRIEF DESCRIPTION OF THE DRAWINGS

FIG. 1 is a cross sectional view of a gas sensor of a first embodiment according to the present invention.

FIG. 2 is a fragmentary illustrative view in enlarged cross section showing a layout of a cushioning filler provided between a gas sensing element and an insulating element holder of the gas sensor shown in FIG. 1 for illustrating a manufacturing method of the present invention.

FIG. 3 is a side view showing a status wherein the gas sensing element is inserted to and fixedly supported with the insulating element holder of the gas sensor shown in FIG. 1.

FIG. 4 is a bottom view showing the relationship between the gas sensing element and the insulating element holder supporting the same.

FIG. 5 is a graph showing results of Example 1 representing the relationship between an average particle diameter of ceramic powder and a binder content.

FIG. 6 is a graph showing results of Example 2 representing the relationship between a ceramic solid content and impact acceleration.

### DETAILED DESCRIPTION OF PREFERRED EMBODIMENTS

Now, a gas sensor of an embodiment according to the present invention and a related method of manufacturing the gas sensor are described below in detail with reference to the accompanying drawings. However, the present invention is construed not to be limited to such an embodiment described below and technical concepts of the present invention may be implemented in combination with other known technologies or the other technology having functions equivalent to such known technologies.

In the following description, it is construed that a portion of the gas sensor adapted to be inserted to an exhaust pipe of an internal combustion engine of a motor vehicle is referred to as a “leading end portion” and an opposite side of the gas sensor exposed to an atmosphere is referred to as a “base end” or a “base end portion”.

Also, it will be appreciated that the gas sensor of the present embodiment according to the present invention may have a wide variety of applications to an oxygen sensor, an A/F sensor, a NOx sensor, etc.

### First Embodiment

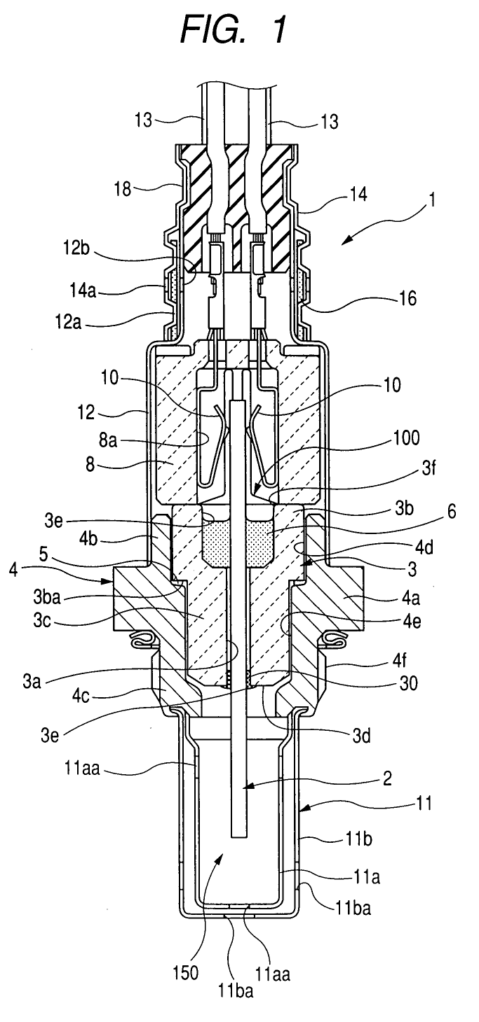

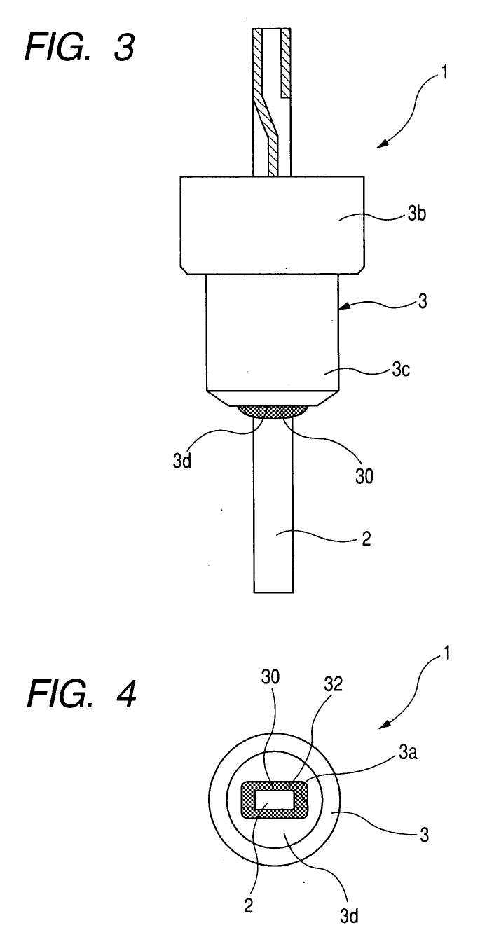

A gas sensor of an embodiment according to the present invention is described below in detail with reference to FIGS. 1 to 4.

As shown in FIG. 1, a gas sensor 1 of the present embodiment comprises a gas sensing element 2 for detecting a concentration of specified gas in measuring gases, an insulating (porcelain) element holder 3 having an element inserting bore 3a through which the gas sensing element 2 longitudinally extends and is held in a fixed place, and a housing 4 internally holding the insulating element holder 3.

As shown in FIG. 1, the housing 4 includes a housing body 4a having its outer periphery formed with a tool-fitting portion 4aa with which a tool (not shown) is engageable, an upper cylindrical body 4b extending from the housing body 4a toward a base end portion of the housing 4, and a lower cylindrical body 4c extending from the housing body 4a toward a leading end portion thereof. The tool-fitting portion 4aa is formed in a substantially hexagonal profile with two facing surfaces of hexagonal surfaces being distanced from each other by a given value.

Further, as shown in FIG. 1, the lower cylindrical body 4c of the housing 4 has an outer periphery formed with a threaded portion 4f that can be screwed into a wall of, for instance, an exhaust pipe of an internal combustion engine for exhaust gases to be detected.

The housing 4 is internally formed with a first large diameter inner wall 4d and a second small diameter inner wall 4e, with a holder rest shoulder 4f being formed between the first and second inner walls 4d, 4e.

The insulating element holder 3 includes a large diameter cylindrical body 3b and a small diameter cylindrical body 3c, with an engaging shoulder 3ba being formed between the cylindrical bodies 3b, 3c.

The insulating element holder 3 is accommodated in the housing 4 such that the large diameter cylindrical body 3a is accommodated in the large diameter inner wall 4d of the housing 4 and the small diameter cylindrical body 3b is accommodated in the small diameter inner wall 4e of the housing 4 with a packing element 5 being interposed between the engaging shoulder 3ba of the insulating element holder 3 and the holder rest shoulder 4f of the housing 4 to provide a sealing effect.

The packing element 5 separates a measuring gas side ambience 100 and an atmospheric side ambience 150 from each other in the gas sensor 1 in a hermetically sealing effect.

The gas sensor 1 of the present embodiment comprises, in addition to the gas sensing element 2, the insulating element holder 3 and the housing 4, an atmospheric side insulator 8, a measuring gas side cover 11 fixedly mounted on an end face of the lower cylindrical body 4c of the housing 4, and an atmospheric side cover 12 fixedly mounted on the upper cylindrical body 4b of the housing 4 by welding The atmospheric side ambience 100 is defined in the atmospheric side cover 12 and the measuring gas side ambience 150 is defined in the measuring gas side cover 11.

The atmospheric side insulator 8 has an axially extending cavity 8a that accommodates therein spring terminals 10, 10 held in electrical contact with electrode terminals (not shown) of the gas sensing element 2. The spring terminals 10, 10 are electrically connected to lead wire portions 13, 13.

The atmospheric side cover 12 has an upwardly extending base end section 12a formed in a smaller diameter than that of the other part and having a plurality of ventilation openings 12b formed at circumferentially spaced positions. The base end section 12a of the atmospheric side cover 12 carries thereon a filter cover 14 formed with a plurality of ventilation openings 14a at circumferentially spaced positions in radial alignment with the ventilation openings 12b formed on the base end section 12a of the atmospheric side cover 12 to introduce atmospheric air into the atmospheric side ambience 100.

A ventilation filer 16 is interposed between the base end section 12a of the atmospheric side cover 12 and the filter cover 14 in a position to provide a waterproof function between the ventilation openings 14a of the filter cover 14 and the ventilation openings 12b of the base end section 12a of the atmospheric side cover 12 while admitting atmospheric air to an inside of the atmospheric side cover 12.

As shown in FIG. 1, furthermore, the base end section 12a of the atmospheric side cover 12 and the filter cover 14 are coupled to each other at a caulked portion 18 with which a rubber bush 20 is fixedly supported. With such a configuration, the rubber bush 20 allows the base end of the gas sensing element 2 to have a waterproof function. The rubber bush 20 internally supports the lead wire portions 13, 13, which are electrically connected to the electrode terminals 10 of the gas sensing element 2.

The measuring gas side cover 11 takes a double-layer structure that includes an inner protecting cover 11a, formed with a plurality of openings 11aa, and an outer protecting cover 11b having a plurality of openings 11ba. Thus, the openings 11aa, 11ba play roles as gas flow ports through which measuring gases are introduced to an inside of the measuring gas side cover 11 in contact with a detecting section 2a of the gas sensing element 2.

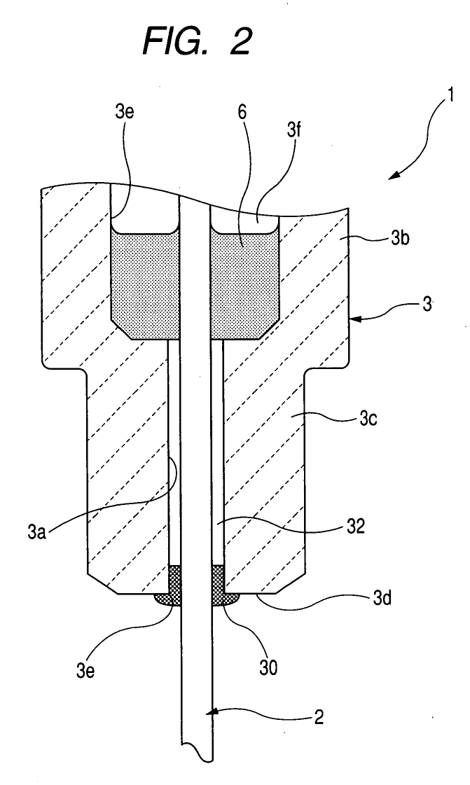

As best shown in FIGS. 1 and 2, the large diameter cylindrical body 3b of the insulating element holder 3 has a cylindrical cavity 3e that is filled with airtight sealant 6. Airtight sealant 6 provides a sealing effect between the gas sensing element 2 and the insulating element holder 3 at a base end of the element holding bore 4c to prevent measuring gases from leaking through a clearance between the gas sensing element 2 and the element inserting bore 3a of the insulating element holder 3 to an upper area of the insulating element holder 3.

Further, the small diameter cylindrical body 3c of the insulating element holder 3 has a leading end face 3d at which a cushioning filler 30 is provided. The cushioning filler 30 is partially filled in a leading end portion of the element inserting bore 3a of the insulating element holder 3 to resiliently support the gas sensing element 2 in fixed place.

The cushioning filler 30 is formed in the leading end portion of the element inserting bore 3a of the insulating element holder 3 by carrying out filling step and firing step in manners described below.

That is, in filling step, ceramic slurry is prepared by mixing at least ceramic powder and binder. Then, ceramic slurry is filled into a ring-like space 32 between the gas sensing element 2 and the element inserting bore 3a in an area close proximity to the end face 3d of the small diameter portion 3c of the insulating element holder 3 as shown in FIG. 2.

In next firing step, ceramic slurry is fired together with the insulating element holder 3 and the gas sensing element 2, thereby forming the cushioning filler 30 in a ring shape contour in cross section as shown in FIG. 4. The cushioning filler 30 provides a cushioning effect through which the gas sensing element 2 is supported with the element inserting bore 3a of the insulating element holder 3.

With the gas sensor 1 shown in FIG. 4, while the gas sensing element 2 and the element inserting bore 3a are shown as having rectangular shapes in cross section, the present invention is not limited to such a structure. In an alternative, the gas sensing element 2 and the element inserting bore 3a may be formed in round or polygonal shapes in cross section if desired.

In preparing ceramic slurry used for filling step, ceramic slurry contains 47 to 53 wt % of ceramic powder for a gross weight of ceramic slurry. In addition, the binder content lies in a value ranging from 5 to 10 wt % for a weight of ceramic solids.

Further, examples of ceramic powder include, for instance, alumina powder, zirconia powder or the like.

Furthermore, examples of binder include alumina sol, aluminum nitrate or the like.

Moreover, the filling step is carried out so as to allow the cushioning filler 30 to be filled in the ring-like space 32 between the gas sensing element 2 and the element inserting bore 3a such that at least four corners of the gas sensing element 2 is sealed and fixed in place on a plane perpendicular to an axis of the gas sensing element 2.

While the gas sensor 1 of the present embodiment is shown in FIG. 4 to have a structure with the gas sensing element 2 having an overall circumference sealed and fixed with the cushioning filler 30, the present embodiment is not limited to such a structure and the gas sensing element 2 may have corner areas sealed and fixed with the cushioning filler 30 with the other areas remaining under unsealed conditions.

Now, a method of manufacturing the gas sensor 1 is described below in detail.

In fabricating the gas sensing element 2, a plurality of given green sheets are laminated and pressed against each other, thereby obtaining an unburned laminate body. Thereafter, the unburned laminate body is burned forming of the gas sensing element 2.

Further, the insulating element holder 3 can be fabricated by firing a ceramic body made of, for instance, alumina or the like.

Thereafter, the gas sensing element 2 is inserted through the element inserting bore 3a of the insulating element holder 3. Then, airtight sealant 6 is poured to the cavity 3e of the insulating element holder 3 from a base end portion 3f of the insulating element holder 3 to fill a clearance in the form of the ring-like space 32 between the insulating element holder 3 and the gas sensing element 2. This enables the gas sensing element 2 to be strongly fixed to the insulating element holder 3 at the base end portion 3f of the insulating element holder 3.

Examples of airtight sealant 6 include suitable materials such as, for instance, crystallized glass, inorganic filling materials or the like.

In forming the cushioning filler 30, filling step is conducted to fill ceramic slurry to the ring-like space 32 between the insulating element holder 3 and the gas sensing element 2, after which firing step is carried out in the manner set forth above.

During filling step, as shown in FIGS. 1 and 2, ceramic slurry is applied to the ring-like space 32 between the element inserting bore 3a and the gas sensing element 2 in an area close proximity to the end face 3d of the insulating element holder 3. That is, ceramic slurry is poured into the ring-like space 32 of the insulating element holder 3 from the element inserting bore 3a at a leading end opening portion 3e thereof. In addition, ceramic slurry is filled in the ring-like space 32 between the element inserting bore 3a and the gas sensing element 2 in an area near the leading end opening portion 3e so as to seal and fix an entire circumference of the gas sensing element 2 on a plane perpendicular to the axis of the gas sensor 1. Moreover, as shown in FIGS. 1 to 4, ceramic slurry is applied so as to overflow from the end face 3d of the small diameter section 3c of the insulating element holder 3 in a ridged state as shown in FIGS. 1 to 4.

In carrying out filling step set forth above, for instance, ceramic powder, binder, water and additive are mixed to each other thereby preparing ceramic slurry as set forth above.

Further, ceramic powder has an average particle diameter in a range from 10 to 30 μm.

Next, firing step is conducted to fire ceramic slurry together with the insulating element holder 3 and the gas sensing element 2 at a given temperature for a given time interval, thereby obtaining the cushioning filler 30. When this takes place, both the gas sensing element 2 and the insulating element holder 3 are heated together with ceramic slurry. This allows binder and water or the like to vaporize, thereby causing ceramic powder components to be solidified and hardened thereby forming the cushioning filler 30.

Thus, with the airtight sealant 6, filled in the cavity 3e of the insulating element holder 3 in the base end portion 3f thereof, and the cushioning filler 30 located in the distal end portion of the insulating element holder 3 on the end face 3d thereof, the gas sensing element 2 can be fixedly retained at two axially spaced positions.

Subsequently, the packing element 5 is inserted to the small diameter cylindrical section 3c of the insulating element holder 3. Then, the insulating element holder 3 and the packing element 3, rigidly carrying thereon the gas sensing element 2 unitized to the insulating element holder 3 by means of the airtight sealant 6 and the cushioning filler 30, are inserted to the housing 4 until the packing element 5 is sandwiched between the annular shoulder 3ba of the large diameter cylindrical section 3b and the annular rest portion 4f of the housing 4. Under such a situation, the large diameter cylindrical section 3b is accommodated in the large diameter inner wall 4d of the housing and the small diameter cylindrical section 3c is accommodated in the small diameter inner wall 4e.

With such a structure set forth above, the gas sensor 1 of the present embodiment has various advantageous effects listed below.

Ceramic slurry contains 47 to 53 wt % of ceramic solids for a gross weight of ceramic slurry and 5 to 10 wt % of binder for a gross weight of the ceramic solids. Thus, the cushioning filler 30 can have adequate strength.

After ceramic slurry filled to the space 32 between the element inserting bore 3a of the insulating element holder 3 and the gas sensing element 2 in the area near the face end 3d of the insulating element holder 3, the insulating element holder 3, the gas sensing element 2 and ceramic slurry are subjected to firing step. Thus, upon completions of filling step and firing step of ceramic slurry, the cushioning filler 30 composed of ceramic slurry and having adequate strength can be formed in the area between the gas sensing element 2 and the insulating element holder 3. Therefore, the presence of the cushioning filler 30 with adequate strength can suppress the gas sensing element 2 from vibrating due to vibration of the internal combustion engine during operation thereof.

That is, with the manufacturing method set forth above, it becomes possible to easily manufacture a gas sensor that can prevent a gas sensing element from damage.

Further, ceramic powder used in filling step has an average particle diameter ranging from 10 to 30 μm. This allows filling step to be effectively carried out such that the cushioning filler 30 is filled between the gas sensing element 2 and the insulating element holder 3 so as to have adequate strength.

As shown in FIG. 4, furthermore, during filling step, ceramic slurry is filled in the ring-like space 32 such that at least four corners of the gas sensing element 2 are supported on a plane perpendicular to the axis of the gas sensor 1. This enables a remarkable reduction in momentum acting on the gas sensing element 2 due to vibration of the gas sensing element 2, while making it possible to effectively absorb impact and vibration applied thereto from an outside.

With the manufacturing method of the gas sensor, as set forth above, it becomes possible to manufacture a gas sensor that has remarkable vibration-proof to provide elongated operating life.

### EXAMPLE 1

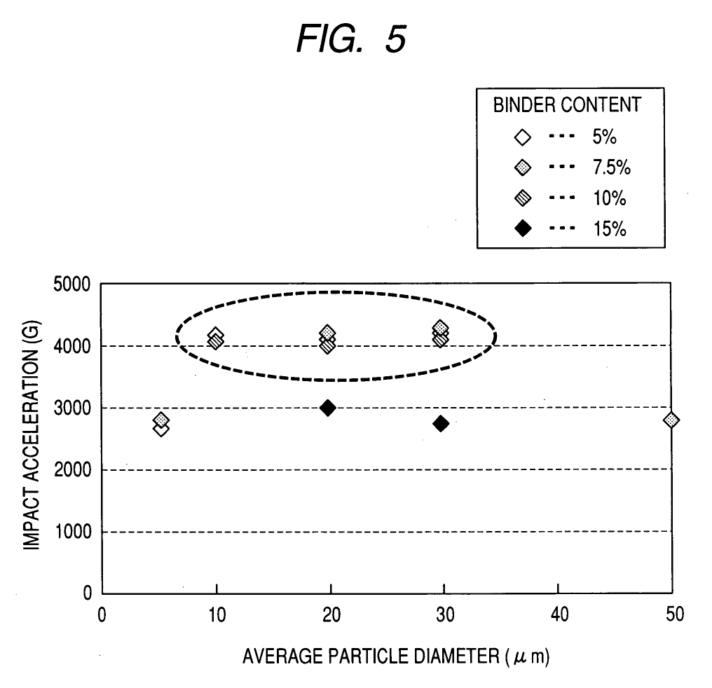

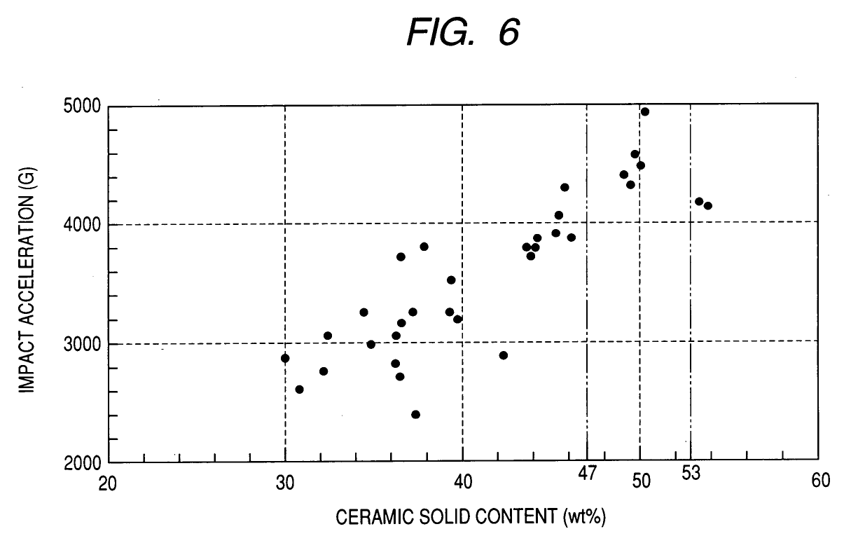

Test pieces were prepared using ceramic slurries composed of binders in various contents and ceramic powders with various particle diameters as ceramic solids. Impact tests were conducted on the resulting test pieces with test results indicated in a graph of FIG. 5.

In conducting impact tests, base end portions of the test pieces were restricted in fixed place and the test pieces were applied with impacts in various magnitudes along a direction perpendicular to an axis of the gas sensing element 2.

Also, component elements of each test piece bear the same reference numerals as those used in FIG. 1.

In this Example 1, gas sensors were fabricated as test pieces using ceramic slurries containing 45 wt % of ceramic solids in a fixed value with binder contents and average particle diameters of ceramic powders altered in various values as described below. That is, the binder contents were altered in various values ranging from 5 to 15 wt %. In addition, the average particle diameters of ceramic powder were altered in various values ranging from 0 to 50 μm. Moreover, ten pieces of samples were prepared for each test piece.

Then, impacts were applied to the ten pieces of the samples and calculations were executed to check an average value of impact accelerations acting on the ten pieces of samples whose gas sensing elements 2 were damaged. FIG. 5 shows the graph in which impact accelerations (G) are plotted in terms of average particle diameters (μm) of ceramic powder.

In making judgments on whether or not damages occurred on the gas sensing elements 2, a voltage was applied to each heater incorporated in each sample to cause electric current flow therethrough and judgment was made by checking whether or not the heater of the gas sensing element 2 was conducting.

Measured results are indicated on the graph shown in FIG. 5. As will be understood from FIG. 5, for the test pieces incorporating ceramic powder containing ceramic powder with an average particle diameter ranging from 10 to 30 μm and having the binder content ranging from 5 to 10 wt %, no damage occurred in the gas sensing elements 2 even when applied with impact acceleration at 4000 G On the contrary, for the other test pieces having cushioning fillers 30 prepared in other compositions, the gas sensing elements 2 encountered with damages even applied with impact acceleration less than 3000 G.

From the above, it is important from a viewpoint of ensuring strength of the cushioning fillers 30 that the binder content lies in a value ranging from 5 to 10 wt % for the weight of ceramic solids and an average particle diameter of ceramic powder lies in a value from 10 to 30 μm.

### EXAMPLE 2

In this Example 2, tests were conducted on test pieces to check the relationship between a ceramic solid content (wt %) in ceramic slurry and impact acceleration applied to the gas sensing elements 2 for damages caused to occur therein with test results indicated in a graph of FIG. 6.

Also, component elements of each test piece bear the same reference numerals as those used in FIG. 1.

In this Example 2, gas sensors were fabricated having cushioning fillers 30 containing ceramic solids in various values. Also, ten pieces of samples were prepared for each test piece.

Thereafter, the samples are applied with impacts in the same ways as those of Example 1 mentioned above.

Then, impacts were applied to the ten pieces of the samples and calculations were executed to check an average value of impact accelerations acting on the ten pieces of samples whose gas sensing elements 2 were damaged. FIG. 6 shows the graph in which impact accelerations (G) are plotted in terms of ceramic solid content (wt %).

In addition, ceramic slurry was selected to have 7.5 wt % of binder content to a weight of ceramic solids and ceramic powder having an average particle diameter of 20 μm.

Example 2 has the other conditions similar to those of Example 1.

Measured results are indicated on the graph shown in FIG. 6. As will be understood from FIG. 6, for the test pieces employing ceramic slurry containing 47 to 53 wt % of ceramic solids, no damage occurred in the gas sensing elements 2 even when applied with impact acceleration at 4100 G On the contrary, for the other test pieces employing ceramic slurry containing ceramic solids by less than 47 wt % and exceeding 53 wt %, damages occurred in the gas sensing elements 2 even when applied with impact acceleration at a rate less than 4100 G.

From the above, it is turned out to be important from a viewpoint of ensuring strength of the cushioning fillers 30 that the content of ceramic solids contained in ceramic slurry lies in a value from 47 to 53 wt %.

While the specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof.

What is claimed is:

1. A method of manufacturing a gas sensor having a gas sensing element for detecting a concentration of specified gas in measuring gases, an insulating element holder having an element inserting bore for supporting the gas sensing element and a housing internally holding the insulating element holder in a fixed place, the method comprising the steps of:
applying an airtight sealant to the insulating element holder on a base end portion thereof for fixedly retaining the gas sensing element; and
locating a cushioning filler between the gas sensing element and the insulating element holder on a leading end portion thereof;
wherein the cushioning filler locating step comprises:
filling a leading end portion of the element inserting bore in an area between the gas sensing element and the insulating element holder with a ceramic slurry containing at least a ceramic powder and a binder; and
firing the ceramic slurry to form the cushioning filler;
wherein the ceramic slurry contains 47 to 53 wt % of ceramic solids for a gross weight of the ceramic slurry and a binder laying in a value ranging from 5 to 10 wt % for a weight of the ceramic solids.

2. The method of manufacturing the gas sensor according to claim 1, wherein:
the ceramic powder has an average particle diameter ranging from 10 to 30 μm in the filling step.

3. The method of manufacturing the gas sensor according to claim 1, wherein:
the filling step is conducted so as to fill the leading end portion of the element inserting bore with the ceramic slurry such that upon completion of the firing step, the cushioning filler seals and fixes the gas sensing element on at least four corners thereof on a plane substantially perpendicular to an axis of the gas sensing element.

4. The method of manufacturing the gas sensor according to claim 1, wherein:
the ceramic powder includes ceramic materials selected from the group consisting of alumina powder and zirconium powder.

5. The method of manufacturing the gas sensor according to claim 1, wherein:
the binder includes materials selected from the group consisting of alumina sol and aluminum nitrate.

6. A method of manufacturing a gas sensor, comprising the steps of:
preparing a gas sensing element for detecting a concentration of specified gas in measuring gases;
preparing an insulating element holder having an element inserting bore through which the gas sensing element extends and is fixedly retained;
forming an airtight sealant between the gas sensing element and the insulating element holder on a base end portion thereto; and
locating a cushioning filler between the gas sensing element and the insulating element holder on a leading end portion thereof;
wherein the cushioning filler locating step comprises:
filling a leading end portion of the element inserting bore in an area between the gas sensing element and the insulating element holder with a ceramic slurry containing at least a ceramic powder and a binder; and
firing the ceramic slurry to form the cushioning filler;
wherein the ceramic slurry contains 47 to 53 wt % of ceramic solids for a gross weight of the ceramic slurry and a binder laying in a value ranging from 5 to 10 wt % for a weight of the ceramic solids.

7. The method of manufacturing the gas sensor according to claim 6, wherein:
the ceramic powder has an average particle diameter ranging from 10 to 30 cm in the filling step.

8. The method of manufacturing the gas sensor according to claim 6, wherein:
the filling step is conducted so as to fill the leading end portion of the element inserting bore with the ceramic slurry such that upon completion of the firing step, the cushioning filler seals and fixes the gas sensing element on at least four corners thereof on a plane substantially perpendicular to an axis of the gas sensing element.

9. The method of manufacturing the gas sensor according to claim 6, wherein:
the ceramic powder includes ceramic materials selected from the group consisting of alumina powder and zirconium powder.

10. The method of manufacturing the gas sensor according to claim 1, wherein:
the binder includes materials selected from the group consisting of alumina sol and aluminum nitrate.

11. A gas sensor comprising:
a cylindrical insulating element holder having an element inserting bore extending from a base end to a distal end thereof;
a gas sensing element extending through the element inserting bore of the insulating element holder;
a cylindrical housing internally supporting the insulating element holder in fixed place;
an airtight sealant provided between the gas sensing element and the insulating element holder on a base end portion thereof; and
a cushioning filler provided between the gas sensing element and the insulating element holder on a leading end portion thereof for sealing a clearance between an inner wall of the element inserting bore and an outer surface of the gas sensing element;
wherein the cushioning filler is formed of a ceramic slurry, including a ceramic powder containing 47 to 53 wt % of ceramic solids for a gross weight of the ceramic slurry and a binder laying in a value ranging from 5 to 10 wt % for a weight of the ceramic solids, which is filled between the gas sensing element and the insulating element holder on the leading end portion thereof upon which the ceramic slurry is fired to form the cushioning filler.

12. The gas sensor according to claim 11, wherein:
the ceramic powder has an average particle diameter ranging from 10 to 30 μm.

13. The gas sensor according to claim 11, wherein:
the element inserting bore of the cylindrical insulating element holder has a rectangular shape in cross section and the gas sensing element has a rectangular shape in cross section smaller than that of the element inserting bore of the cylindrical insulating element holder to provide a ring-like space in which the cushioning filler is formed.

14. The gas sensor according to claim 11, wherein:
the ceramic powder includes ceramic materials selected from the group consisting of alumina powder and zirconium powder.

15. The gas sensor according to claim 11, wherein:
the binder includes materials selected from the group consisting of alumina sol and aluminum nitrate.
